(19) United States
(12) Patent Application Publication
(10) Pub. No.: US 2008/0218921 A1
(43) Pub. Date: Sep. 11, 2008

(54) Control Circuit with Reduced Load for a Bypass Switch

(75) Inventors: Heino Marten Burema, Mierlo (NL); Gerardus Elisabeth Joseph Maria Pas, Valkenswaard (NL)

Correspondence Address: DeMont & Breyer, LLC, 100 Commons Way, Ste. 250, Holmdel, NJ, 07733, US

(73) Assignee: ELECTRISCHE APPARATENFABRIEK CAPAX B.V., NL-5652 BA Eindhoven (NL)

(21) Appl. No.: 11/911,459

(22) PCT Filed: Apr. 13, 2006
(86) PCT No.: PCT/NL06/50083

§ 371 Date: Apr. 15, 2008

(30) Foreign Application Priority Data
Apr. 15, 2005 (NL) 1028778

(51) Int. Cl. H02H 9/02; H02P 1/02

(52) U.S. Cl. 361/57; 318/434

(57) ABSTRACT

The invention relates to a control circuit for controlling the power supplied from a power source to an electromotor, whereby the control circuit comprises a semiconductor switching element connected in series to the electromotor and the power source for controlling the power supplied to the electromotor and operating means connected to the semiconductor switching element for controlling the semiconductor switching element, whereby the operating means are arranged for controlling the semiconductor switching element when the control range of the semiconductor switching element is exceeded for at least a moment in a fully conducting state. Because the current reaches this value for at least a moment, the switch no longer has to interrupt a relatively large current.

The present invention relates to a control circuit for controlling the power supplied from a power source to an electromotor, whereby the control circuit comprises a semiconductor switching element connected in series to the electromotor and the power source for controlling the power supplied to the electromotor and operating means connected to the semiconductor switching element for controlling the semiconductor switching element.

Such control circuits are generally known in the form of control circuits for electric hand tools. With such a circuit, the semiconductor switching element switches the motor current between a minimum value and a maximum value. The range between the minimum value and the maximum value is referred to as the control range. The minimum value is generally greater than zero to supply sufficient power to the electromotor enabling the electromotor to start up when it is switched on, thus preventing current from flowing through an electromotor at a standstill for any duration of time. The maximum value is generally less than 100% to prevent large currents from flowing through the semiconductor switching element. These large currents can indeed heat the semiconductor switching element to such an extent that it will be destroyed.

It should be noted that such circuits powered by DC sources as well as AC sources are known. With DC sources such as an accumulator, a MOSFET usually acts as a semiconductor switching element. With power supplied from AC sources, use is made of a thyristor or triac. It should be noted that a thyristor has a limited control range, because it can only adjust the positive part of a complete phase. The maximum value of the control range can therefore never exceed 50%.

According to the prior art, when power to be supplied to the electromotor is increased, a bypass switch arranged in parallel to the semiconductor switching element will shortcircuit once the maximum value of the range of the semiconductor switching element has been reached. As a result, no further current will flow through the semiconductor switching element and the motor current will increase from the value at the maximum of the range to the full value. Indeed this prevents the semiconductor switching element from being subjected to an excessive load.

In practice this does not present any problems; the power control options of driven tools are primarily used within the low part of the range. If greater power is desired, accurate control is unnecessary and the bypass switch is closed.

However this creates a problem when adjusting back the motor current from the maximum value when the bypass switch is closed to the maximum value of the current flowing through the semiconductor switching element. When the bypass switch is opened, it has to interrupt a current of a significant value, which in turn can seriously reduce the life of the contacts. Manufacturers of electric hand tools are increasingly placing stringent test requirements on these switches, and in particular on the contacts thereof, which in turn increases the cost price of such switches.

The object of the invention is to provide such a control circuit whereby less stringent requirements are placed on this bypass switch so that a longer life is achievable.

This object is achieved in that the operating means are arranged for controlling the semiconductor switching element when the control range of the semiconductor switching element is exceeded for at least a moment in a fully conducting state. Because the current reaches this value for at least a moment, the switch no longer has to interrupt a relatively large current.

According to a first embodiment, the operating means are arranged for controlling the semiconductor switching element when the control range of the semiconductor switching element is exceeded in a fully conducting state. A bypass switch will indeed no longer be necessary, thus preventing the problems relating thereto. However, this embodiment requires semiconductor switching elements having properties such that they can conduct the full motor current. With advances made in the development of semiconductor switching elements, such elements are becoming more easily available. It should be noted that the full conductance of the semiconductor switching element forms a smaller load for the element than would have been assumed; the switching losses are indeed eliminated.

According to an alternative embodiment, the control circuit comprises a bypass switch for bypassing the semiconductor switching element, whereby the operating means are arranged for closing the bypass switch when the control range of the semiconductor switching element is exceeded and that when the motor current to be supplied to the electromotor is reduced, the motor current flowing directly after the bypass switch is opened corresponds at least approximately to the motor current flowing when the bypass switch is closed.

In particular this amounts to the measure of arranging the control circuit for controlling the semiconductor switching element in a fully conducting state prior to the opening of the bypass switch.

As a result of this measure, the motor current is carried by the semiconductor switching element, so that the bypass switch does not have to interrupt any large current and is not subjected to such a heavy load.

It is nevertheless attractive to arrange the control circuit in such a way that, in addition to when the power to be supplied to the electromotor is increased, the motor current flowing when the maximum value of the control range of the semiconductor switching element is reached corresponds at least approximately to the motor current flowing when the bypass switch is closed.

This measure enables the control circuit to be greatly simplified, because there does not have to be any distinction made between increasing or decreasing the power to be supplied to the motor.

In particular this amounts to the measure of arranging the control circuit for controlling the semiconductor switching element in a fully conducting state when the motor current is increased prior to the closing of the bypass switch.

According to yet another embodiment, the control range of the semiconductor element extends to full conductance. This embodiment is particularly simple in control technology, although it requires a semiconductor that can handle the load of a large current in a partially conducting state, in other words in a switching state. It is expected that such semiconductors will become increasingly available. In other respects, the type of appliance in which the circuit is arranged also plays a role, as does the way in which the appliance is used.

It is however also possible for the control range of the semiconductor switching element to extend to partial conductance and for the operating means to be arranged for controlling the semiconductor switching element in a fully conducting state for a short period of time. This embodiment comprises a control strategy that largely corresponds to that of a control circuit pertaining to the prior art. The control circuit is however arranged for controlling the semiconductor switching element in a fully conducting state contiguous to the bypass switch switching on and off. Because this element always conducts for a short period of time only, the risk of the element overloading is minimal.

A more specific embodiment provides for a monitoring element thermally connected to the semiconductor switching element for reducing the current flowing through the switching element when a maximum temperature of the semiconductor switching element is exceeded.

This makes it possible for the semiconductor switching element to conduct the maximum current directly after the bypass switch opens. In many cases, this current will lead to a thermal overload of the semiconductor switching element, which will destroy the semiconductor switching element if it continues. Through the intervention of the monitoring element, this current will be reduced to the range at which there will no longer be any thermal overload.

With the embodiments described above, the control circuit controls the semiconductor switching element toward its maximum conductance, after which the bypass switch opens. It is assumed in this respect that the nominal value of the motor current is when the bypass switch opens. There may obviously be circumstances in which this assumption is not correct, for example if the motor is subjected to a heavy load. In this event, the opening of the bypass switch would lead to a sharp change in the motor current, causing precisely those undesired related effects that the invention is attempting to prevent.

To this end, a further preferred embodiment of the invention provides for the measure whereby the bypass switch will only open when the controlling circuit controls the semiconductor switching element in such a way that the motor current approximately corresponds to the motor current flowing when the bypass switch is closed, as the trigger is allowed to return.

In this way, the degree of conductance of the semiconductor switching element is adjusted so to speak to the motor current prior to the bypass switch opening, so that the motor current changes as little as possible when the bypass switch opens.

The problem for which the present invention provides a solution is applicable for DC motors as well as AC motors. If DC motors are used, the invention provides for an embodiment whereby the voltage source is a DC voltage source and the semiconductor switching element is formed by a MOSFET.

If AC motors are used, the invention provides for an embodiment whereby the voltage source is an AC voltage source and the semiconductor switching element is formed by a triac. It should be noted that with AC voltage motors, thyristors are also used, but these semiconductor switching elements can only conduct for a maximum of 50% of the time, which means that they cannot carry the current flowing through a closed bypass switch.

According to a further preferred embodiment, the operating means comprise a trigger switch, which controls the controlling circuit as it is pushed in further in such a way that the semiconductor switching element conducts within its control range, and which closes the bypass switch when it is pushed in past the position at which the semiconductor switching element is at maximum conductance, whereby the controlling circuit is arranged for controlling the semiconductor switching element when the trigger switch returns from the position at which the bypass switch is closed, until a degree of conductance is achieved at which the motor current is substantially equal to the motor current flowing when the bypass switch is closed. The invention implements this measure within the usual structure of a control circuit provided with a trigger.

The present invention relates not only to such a control circuit, but also to an electric device that is provided with such a control circuit.

It should be noted that the main area of application is in devices equipped with electromotors. However the invention can also be applied in devices that are equipped with other energy converters having an inductive nature.

Furthermore, the invention in particular relates to electric hand tools that are provided with such a control circuit.

This object is furthermore achieved by means of a method for controlling the power supplied from a voltage source to an electromotor, comprising the increasing of power supplied to the electromotor by controlling a semiconductor switching element within its range by means of a control circuit, and for then bypassing the semiconductor switching element once it has reached the maximum value of its range, whereby the control circuit controls the semiconductor switching element at least when the power to be supplied to the electromotor is reduced, in such a way that the motor current flowing when the semiconductor switching element reaches the maximum value of its range corresponds at least approximately to the motor current flowing through the closed bypass switch.

Further features of the present invention will emerge from the accompanying drawings, in which the following are shown:

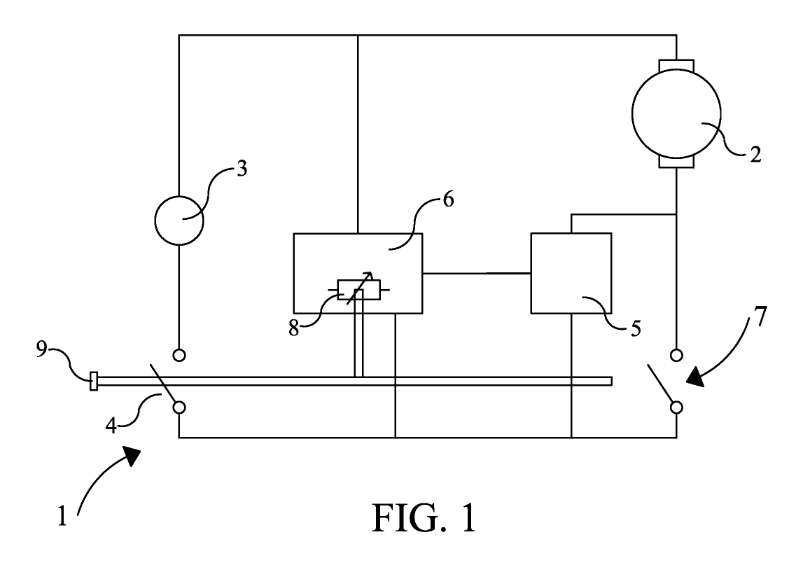

FIG. 1: a circuit diagram of a first embodiment according to the present invention;

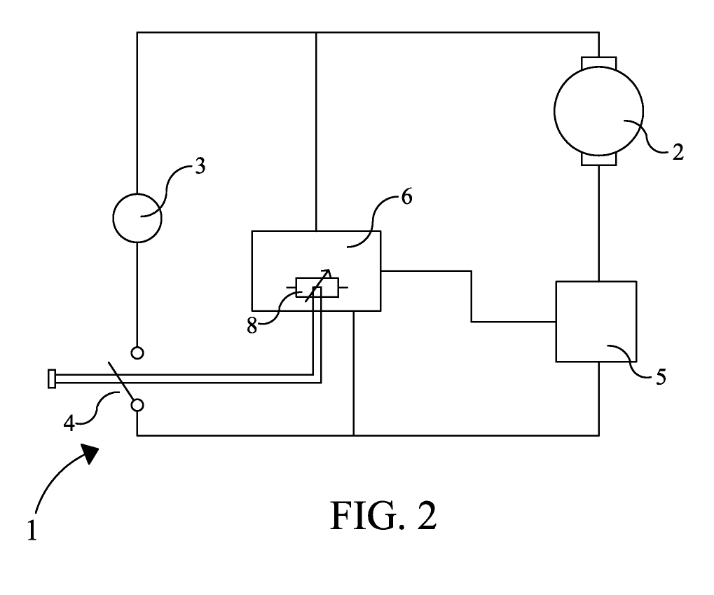

FIG. 2: a circuit diagram of a second embodiment according to the present invention;

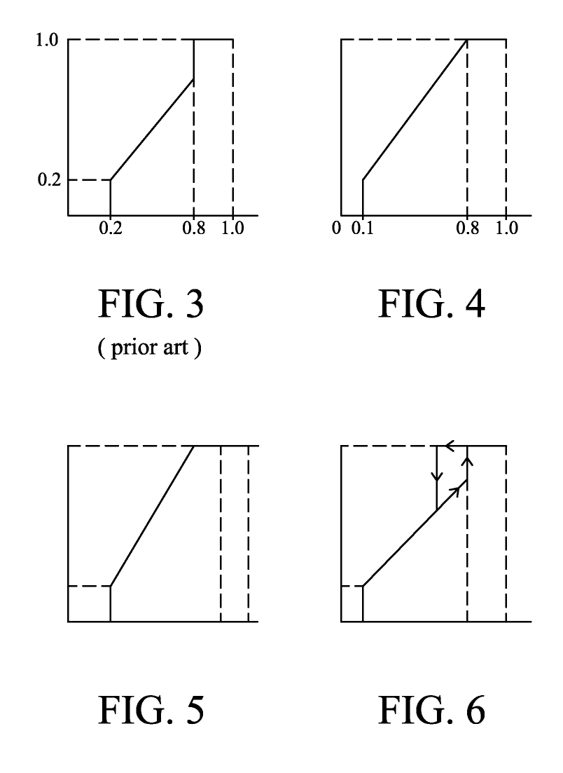

FIG. 3: a graph showing the value of the motor current as a function of the position of a trigger to operate a control circuit according to the prior art;

FIG. 4: a graph corresponding to FIG. 3 according to a first control strategy of the invention;

FIG. 5: a graph corresponding to FIGS. 3 and 4 according to a second control strategy of the invention; and

FIG. 6: a graph corresponding to FIGS. 3, 4 and 6 according to a third control strategy of the invention.

FIG. 1 shows a control circuit indicated in its entirety by the number 1, which controls the power supplied to an electromotor 2. The control circuit 1 is supplied by a voltage source 3. The control circuit 1 comprises a switch 4 with which the circuit can be switched on, positioned between the voltage source 3 and the electromotor 2, a semiconductor switching element connected in series to the switch 4, a controlling circuit 6 for the semiconductor switching element 5 and a bypass switch 7 positioned in parallel to the semiconductor switching element 5. To operate the switch 4 and an adjustable resistor 8 incorporated in the controlling circuit 6, a trigger 9 is affixed which initially closes the switch 4 as it is pushed in further, then adjusts the adjustable resistor 8 for controlling the semiconductor switching element and closes the bypass switch at the end of its distance of travel. Such a circuit forms the prior art.

This is reflected in a graph, as shown in FIG. 3. When the trigger 9 is pushed in past 20% of its path, the switch 4 closes. The controlling circuit controls the semiconductor switching element 5 within its range from the minimum to the maximum value. After reaching the maximum value, the trigger 9 closes the bypass switch 7.

As the trigger 9 is allowed to return, as a result of the action of a spring connected to the trigger 9, the bypass switch 9 will initially be opened, causing the value of the current flowing through electromotor 2 to suddenly drop from its maximum value to the maximum within the range of the semiconductor switching element 5. This change leads to a heavy load being placed on the bypass switch 7. As the trigger 9 continues to move back, the conductance of the semiconductor switching element 5 then reduces to its minimum value, after which the switch 4 opens and the machine stops.

To prevent the problems referred to above with respect to the sudden change in motor current, the invention according to an embodiment proposes increasing the maximum value of the range of the semiconductor switching element 5 to the value of the motor current when the bypass switch 7 is closed. The resultant graph is shown in FIG. 3. In this case, there is no or barely any change in current when the bypass switch opens or closes, thus preventing any problems relating to a change in current. For this to happen, it is obviously necessary for the semiconductor elements 5 used to allow a current to flow when they are in a fully conducting state that corresponds to the current flowing when a bypass switch is closed. With AC applications, this excludes thyristors and other elements that only conduct in one half of the phase.

With the characteristic shown in FIG. 4, only the maximum value of the range is increased to the value corresponding to the value of the current when the bypass switch is closed. It is in principle possible to apply variations in this control strategy, for example depending on the semiconductor switching elements used. For instance FIG. 5 shows a control characteristic, whereby the maximum value of the current has already been achieved in a previous position of the trigger.

This obviously requires the semiconductor switching element to be able to handle the thermal load thus created. It is possible to increase the thermal loadability for example by applying more efficient cooling.

The characteristic shown in FIG. 6 reflects a degree of hysteresis. The characteristic is hereby direction-dependent; when the trigger 9 is pushed in, the current may undergo a sudden jump, but when the trigger is allowed to return, there is no such jump. This is an attractive embodiment because when the current is increased, the thermal problems pertaining to a heavy load on the semiconductor switching element are prevented. When the load is reduced, these problems do arise, but in this respect they are a direct and unavoidable consequence of the measures according to the invention. This characteristic nevertheless requires a more complex controlling circuit.

Although this is not shown in the figure, it is possible to position a heat detector in the vicinity of the semiconductor switching element. This detector can then be connected to the controlling circuit and ensures that when a temperature is exceeded, the load of the semiconductor switching element is reduced by switching off the semiconductor switching element or by reducing the conductance thereof in some other way.

FIG. 2 shows an embodiment that is different in principle; this embodiment does not include the bypass switch. The function of the bypass switch, namely the full conductance of current, is replaced by the facility to control the semiconductor switching element in a fully conducting state. This switching element obviously has to be properly dimensioned to this end, but this is expected to become easier with developments in power semiconductor technology. It should be noted that problems pertaining to the mechanical bypass switch are thus eliminated. In other respects it is also possible with this configuration to apply the various control strategies pertaining to the configuration with a bypass switch.

The following claims are presented for examination:

1. Control circuit for controlling the power supplied from a power source to an electromotor, whereby the control circuit comprises:
a semiconductor switching element connected in series to the electromotor and the power source, for controlling the power supplied to the electromotor; and
operating means connected to the semiconductor switching element for controlling the semiconductor switching element, characterized in that the operating means are arranged for controlling the semiconductor switching element when the control range of the semiconductor switching element is exceeded for at least a moment in a fully conducting state.

2. Control circuit according to claim 1, characterized in that the operating means are arranged for controlling the semiconductor switching element when the control range of the semiconductor switching element is exceeded in a fully conducting state.

3. Control circuit according to claim 1, characterized in that the control circuit further comprises a bypass switch for bypassing the semiconductor switching element, in that the operating means are arranged for closing the bypass switch when the control range of the semiconductor switching element is exceeded and in that, when the motor current to be supplied to the electromotor is reduced, the motor current flowing directly after the bypass switch is opened corresponds at least approximately to the motor current flowing when the bypass switch is closed.

4. Control circuit according to claim 3, characterized in that, when the power to be supplied to the electromotor is increased, the motor current flowing directly before the bypass switch closes corresponds at least approximately to the motor current flowing when the bypass switch is closed.

5. Control circuit according to claim 3, characterized in that the control range of the semiconductor switching element extends to its fully conducting state.

6. Control circuit according to claim 3, characterized in that the control range of the semiconductor switching element extends to a partially conducting state and in that the operating means are arranged for controlling the semiconductor switching element for a short period of time in a fully conducting state.

7. Control circuit according to claim 5, characterized by a monitoring element thermally connected to the semiconductor switching element for reducing the current flowing through the semiconductor switching element when a maximum temperature of the switching element is exceeded.

8. Control circuit according to claim 3, characterized in that the bypass switch will only open when the controlling circuit controls the semiconductor switching element in such a way that the motor current approximately corresponds to the motor current flowing when the bypass switch is closed, as the trigger is allowed to return.

9. Control circuit according to claim 1, characterized in that the voltage source is a DC voltage source and the semiconductor switching element is formed by a MOSFET.

10. Control circuit according to claim 1, characterized in that the voltage source is an AC voltage source and the semiconductor switching element is formed by a TRIAC.

11. Control circuit according to claim 3, characterized in that the operating means comprise a trigger switch, which controls the controlling circuit as it is pushed in further in such a way that the semiconductor switching element conducts within its control range, and which closes the bypass switch when it is pushed in past the position at which the semiconductor switching element is at maximum conductance, whereby the controlling circuit is arranged for controlling the semiconductor switching element when the trigger switch returns from the position at which the bypass switch is closed, until a degree of conductance is achieved at which the motor current is substantially equal to the motor current flowing when the bypass switch is closed.

12. Electric device, characterized by a control circuit according to claim 1.

13. Electric hand tool, characterized by a control circuit according to claim 1.

14. Method for controlling the power supplied from a voltage source to an electromotor, comprising the increasing of power supplied to the electromotor by controlling a semiconductor switching element within its range by means of a control circuit, and for then bypassing the semiconductor switching element once it has reached the maximum value of its range,
characterized by the control circuit
controlling the semiconductor switching element at least when the power to be supplied to the electromotor is reduced, in such a way that the motor current flowing when the semiconductor switching element reaches the maximum value of its range corresponds at least approximately to the motor current flowing through the closed bypass switch.
